(19) United States
(12) Patent Application Publication
(10) Pub. No.: US 2026/0037750 A1
(43) Pub. Date: Feb. 5, 2026

(54) METHOD AND DEVICE FOR PROVIDING A DESCRIPTION OF A COMPARISON OF A SURROUNDING AREA WITH A DIGITAL MAP

(71) Applicant: Robert Bosch GmbH, Stuttgart (DE)

(72) Inventor: Thomas Wenzel, Hamburg (DE)

(21) Appl. No.: 19/273,423

(22) Filed: Jul. 18, 2025

(30) Foreign Application Priority Data
Aug. 2, 2024 (DE) 10 2024 207 365.2

(51) Int. Cl. G06F 40/40; G01C 21/00; G06V 10/74; G06V 10/82; G06V 20/58

(52) U.S. Cl. CPC G06F 40/40; G01C 21/38; G06V 10/74; G06V 10/82; G06V 20/58

(57) ABSTRACT

Method and device for providing a description of a comparison of a surrounding area with a digital map. The method includes a step of acquiring surrounding area data value sets that represent the surrounding area of a vehicle, wherein this surrounding area includes static and/or dynamic objects, a step of reading in the digital map, wherein the digital map represents a digital image of the surrounding area of the vehicle, a step of creating the comparison of the surrounding area data value sets with the digital map, a step of creating the description of the comparison by means of a large language model, wherein the description represents at least a degree of correspondence of the static and/or dynamic objects with the digital image, and a step of providing the description.

### CROSS REFERENCE

The present application claims the benefit under 35 U.S.C. § 119 of Germany Patent Application No. DE 10 2024 207 365.2 filed on Aug. 2, 2024, which is expressly incorporated herein by reference in its entirety.

### FIELD

The present invention relates, inter alia, to a method for providing a description of a comparison of a surrounding area with a digital map, wherein surrounding area data value sets are acquired and compared with a digital map. A description of the comparison is then created and provided by means of a large language model.

### SUMMARY

According to an example embodiment of the present invention, a method for providing a description of a comparison of a surrounding area with a digital map comprises a step of acquiring surrounding area data value sets that represent the surrounding area of a vehicle, wherein this surrounding area comprises static and/or dynamic objects, and a step of reading in the digital map, wherein the digital map represents a digital image of the surrounding area of the vehicle. The method further comprises a step of creating the comparison of the surrounding area data value sets with the digital map, a step of creating the description of the comparison by means of a large language model (LLM), wherein the description represents at least a degree of correspondence of the static and/or dynamic objects with the digital image, and a step of providing the description.

According to an example embodiment of the present invention, the acquisition of the surrounding area data value sets is carried out by means of a surrounding area sensor system. A surrounding area sensor system is understood to mean at least one video sensor and/or at least one radar sensor and/or at least one lidar sensor and/or at least one ultrasonic sensor and/or at least one further sensor that is designed to detect a surrounding area of a vehicle—in particular, the surrounding area features (here: static and/or dynamic objects) of this surrounding area—in the form of sensor data values (here: surrounding area data value sets). In one possible example embodiment, the surrounding area sensor system comprises, for example, a computing unit (processor, working memory, hard drive) with suitable software and/or is connected to such a computing unit for this purpose.

Static objects include, for example, infrastructure features (road markings, crash barriers, etc.) and/or traffic signs (street signs, traffic lights, etc.) and/or structural features (buildings, bridges, tunnels, etc.). Dynamic objects include, for example, other road users (cars, trucks, pedestrians, etc.) that are moving or (temporarily) stationary at the moment of detection.

According to an example embodiment of the present invention, each surrounding area data value set can comprise at least one point in time and/or one position specification when detecting the corresponding surrounding area. The surrounding area data value sets can, for example, contain further information such as traffic information and/or weather information and/or context information (for example, detailed information about the driving scenario, etc.).

A digital map, as a digital image of a surrounding area, is understood to mean a map that is present in the form of (map) data values on a storage medium. For example, the map is designed to comprise one or more map layers, wherein one map layer, for example, shows a map from the bird's eye view (course and position of roads, buildings, landscape features, etc.). This corresponds to a map of a navigation system, for example. A further map layer comprises, for example, a radar map, wherein surrounding area features comprised by the radar map are stored along with a radar signature. A further map layer comprises, for example, a lidar map, wherein surrounding area features comprised by the lidar map are stored along with a lidar signature. Furthermore, the map can additionally or alternatively comprise features that are not visible in the corresponding surrounding area. This includes, for example, a so-called centerline, which lies within a lane and which an (automated) vehicle can use to orient itself—for example, as part of trajectory planning—and/or further features that are particularly relevant for planning longitudinal and lateral movements of a vehicle.

In one example embodiment of the present invention, the map is designed as a highly accurate map. The highly accurate map is in particular designed in such a way that it is suitable for the navigation of an automated vehicle. This is understood to mean, for example, that the highly accurate map is designed to determine a highly accurate position of this automated vehicle by comparing stored surrounding area features with acquired sensor data values of this automated vehicle. For this purpose, the highly accurate map, for example, comprises said surrounding area features along with highly accurate position specifications (coordinates). In this context, a map is in particular understood to mean a globally accurate map.

A highly accurate position is understood to mean a position which is accurate within a specified coordinate system, e.g., WGS84 coordinates, in such a way that this position does not exceed a maximum permitted uncertainty. The maximum uncertainty may depend on the surrounding area, for example. Furthermore, the maximum uncertainty can depend, for example, on whether a vehicle is operated manually or in a semi-, highly or fully automated manner (corresponding to one of SAE levels 1 to 5). In principle, the maximum uncertainty is so low that safe operation of the automated vehicle is in particular ensured. For a fully automated operation of the automated vehicle, the maximum uncertainty is, for example, in an order of magnitude of about 10 centimeters.

An automated vehicle is understood to mean a semi-, highly or fully automated vehicle according to one of SAE levels 1 to 5 (see standard SAE J3016).

The method according to the present invention advantageously achieves the object of providing a method for describing a comparison of a surrounding area with a digital map. The above-mentioned object is achieved by means of the method according to the present invention in particular by the fact that the comparison of the surrounding area data value sets with the digital map and the description of this comparison are created by means of a large language model (LLM). This leads, for example, to an explanation of the fusion of the surrounding area data value sets and the digital map described here for developers in the development process or for validation purposes. This makes it easier to further develop systems of this type, because problems and possible solutions are recognized more quickly. Furthermore, helpful information for an occupant of an (automated) vehicle, such as [from the perspective of the (automated) vehicle] “I am driving more slowly here because my map information does not match the recognized construction site,” etc., can be created and displayed in the vehicle. This could also be used for interaction between the (automated) vehicle and an occupant (or driver), for example to confirm whether an analysis (“Is this really a construction site?”) is correct. The response could be reported back (to a cloud) as data-based information (label) and used there for improving the digital map.

According to an example embodiment of the present inventio, preferably, the LLM used has been trained in advance to create a text-based output from sensor-based data, in particular from the acquired surrounding area data values, wherein this text-based output represents a transcription of a scene.

The training of the LLM used is carried out in particular by creating pairs from input data—here: the representation of a scene (road layout, road surface condition, infrastructure features, traffic signs, road markings, lane arrangement, presence of other vehicles, pedestrians, accidents, construction sites, etc.)—and corresponding text outputs. These pairs can be generated algorithmically/manually, for example, by either having explanatory texts annotated entirely manually by humans or, for example, by algorithmically recognizing the absence of lines or the appearance of traffic signs in the sensor inputs compared to the input map, from which text modules are generated that only need to be weighted by humans (for example, in a specified scene, a recognized construction site is crucial and not that certain lines were not recognized, which are present in the corresponding digital map). In particular, LLMs can be used to output a scene description for given sensor inputs.

Preferably, according to an example embodiment of the present invention, creating the comparison, depending on specified usage criteria, is carried out by means of a neural network architecture.

A neural network architecture is, for example, a network architecture such as MapTR, TopoNet, etc. The neural network architecture receives as input data (here: surrounding area data value sets) which were acquired by a surrounding area sensor system. The digital map is used as further input, which (as explained above) comprises, for example, lane markings, traffic signs and/or other non-semantically describable (but recognizable) surrounding area features. Information (in the form of [output] data) is generated as output, which represents the comparison carried out as a result. Any output representation is possible, depending on the requirements (creating a new digital map, planning a driving task, etc.), wherein the representation can also comprise, for example, parts of the digital map, dynamic objects, etc.

Preferably, according to an example embodiment of the present invention, providing the description comprises a visual and/or acoustic output of this description.

Providing the description is understood to mean, for example, that it is provided in the form of digital data in such a way that it can be requested and received by a vehicle, for example by means of a radio connection. In an alternative or additional embodiment, the description can also be retrieved by map developers for improving or adapting the digital map, wherein the description is output, for example, as a protocol on a display device (screen, etc.).

According to an example embodiment of the present invention, the device, in particular a computing unit, is configured to perform all steps of the method for providing a description of a comparison of a surrounding area with a digital map. A computing unit is understood to mean, for example, a server or a server network or a cloud or a control unit in a vehicle.

According to an example embodiment of the present invention, the device or computing unit comprises a processor, working memories, a storage medium, and suitable software in order to perform the method according to an example embodiment of the present invention. Furthermore, the device comprises an interface in order to transmit and receive data values by means of a wired and/or wireless connection, for example with corresponding devices of vehicles (control units, communication devices, surrounding area sensor system, navigation system, etc.) and/or further off-board devices (server, cloud, etc.).

Furthermore, a computer program is provided according to an example embodiment invention. The computer program comprises commands that, when the computer program is executed by a computer, cause the computer to perform a method according to one of the embodiments of the present invention for providing a description of a comparison of a surrounding area with a digital map. In one embodiment, the computer program corresponds to the software comprised by the second device.

Furthermore, a machine-readable storage medium on which the computer program is stored is provided.

Advantageous developments of the present invention are disclosed herein.

### BRIEF DESCRIPTION OF THE DRAWINGS

Exemplary embodiments of the present invention are shown in the figures and explained in more detail in the following description.

FIG. 1 shows an exemplary embodiment of the method according to the present invention for providing a description of a comparison of a surrounding area with a digital map in the form of a flow chart.

### DETAILED DESCRIPTION OF EXAMPLE EMBODIMENTS

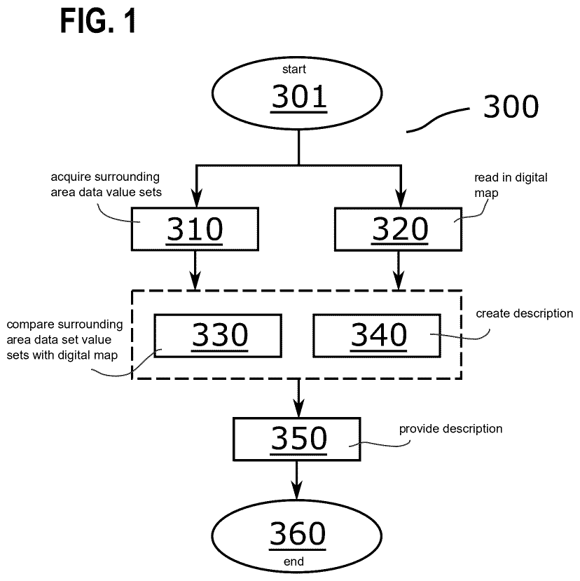

FIG. 1 shows an exemplary embodiment of a method 300 for providing 350 a description of a comparison of a surrounding area with a digital map.

In step 301, the method 300 starts.

In step 310, surrounding area data value sets that represent the surrounding area of a vehicle are acquired. This surrounding area comprises static and/or dynamic objects.

In step 320, the digital map is read in, wherein the digital map represents a digital image of the surrounding area of the vehicle.

Steps 310 and 320 can run in parallel or in any order.

In step 330, the comparison of the surrounding area data value sets with the digital map is created.

In step 340, the description of the comparison is created by means of a large language model (LLM), wherein the description represents at least a degree of correspondence of the static and/or dynamic objects with the digital image.

Steps 330 and 340 can be performed either sequentially or in parallel. Here, “in parallel” means that the comparison and the description of the comparison are created together. This allows the formation of the LLM and the training of the neural network architecture to be performed in parallel.

In step 350, the description is provided.

In step 360, the method 300 ends.

What is claimed is:

1. A method for providing a description of a comparison of a surrounding area with a digital map, the method comprising the following steps:
acquiring surrounding area data value sets that represent a surrounding area of a vehicle, wherein the surrounding area includes static and/or dynamic objects;
reading in the digital map, wherein the digital map represents a digital image of the surrounding area of the vehicle;
creating the comparison of the surrounding area data value sets with the digital map;
creating the description of the comparison using a large language model (LLM), wherein the description represents at least a degree of correspondence of the static and/or dynamic objects with the digital image; and
providing the description.

2. The method according to claim 1, wherein the LLM has been trained in advance to create a text-based output from sensor-based data, from the acquired surrounding area data values, wherein the text-based output represents a transcription of a scene and/or an event.

3. The method according to claim 1, wherein creating of of the comparison, depending on specified usage criteria, is carried out using a neural network architecture.

4. The method according to claim 1, wherein the providing of the description includes a visual and/or acoustic output of this description.

5. A device, comprising:
a control unit configured to provide a description of a comparison of a surrounding area with a digital map, the control unit configured to:
acquire surrounding area data value sets that represent a surrounding area of a vehicle, wherein the surrounding area includes static and/or dynamic objects;
read in the digital map, wherein the digital map represents a digital image of the surrounding area of the vehicle;
create the comparison of the surrounding area data value sets with the digital map;
create the description of the comparison using a large language model (LLM), wherein the description represents at least a degree of correspondence of the static and/or dynamic objects with the digital image; and
provide the description.

6. A non-transitory machine-readable storage medium on which is stored a computer program for providing a description of a comparison of a surrounding area with a digital map, the computer program, when executed by a computer, causing the computer to perform the following steps:
acquiring surrounding area data value sets that represent a surrounding area of a vehicle, wherein the surrounding area includes static and/or dynamic objects;
reading in the digital map, wherein the digital map represents a digital image of the surrounding area of the vehicle;
creating the comparison of the surrounding area data value sets with the digital map;
creating the description of the comparison using a large language model (LLM), wherein the description represents at least a degree of correspondence of the static and/or dynamic objects with the digital image; and
providing the description.
